(19) United States
(12) Patent Application Publication
(10) Pub. No.: US 2024/0073474 A1
(43) Pub. Date: Feb. 29, 2024

(54) SYSTEMS AND METHODS FOR DISPLAY SYNCHRONIZATION

(71) Applicant: Apple Inc., Cupertino, CA (US)

(72) Inventor: Kevin M. LYNCH, Woodside, CA (US)

(21) Appl. No.: 18/359,820

(22) Filed: Jul. 26, 2023

Related U.S. Application Data
(60) Provisional application No. 63/373,848, filed on Aug. 29, 2022.

(51) Int. Cl. H04N 21/43; H04N 21/414

(52) U.S. Cl. CPC H04N 21/43076; H04N 21/41407

(57) ABSTRACT

Synchronization of media playback on multiple displays can provide for a shared experience for those users and devices within the shared or enclosed space. In some embodiments, in accordance with a determination that one or more criteria are satisfied, synchronized playback of the media content on a display of multiple electronic devices is initiated. In some embodiments, in accordance with a determination that the one or more criteria are not satisfied, synchronized playback of the media content on the multiple electronic devices is not initiated.

### CROSS-REFERENCE TO RELATED APPLICATIONS

This application claims the benefit of U.S. Provisional Application No. 63/373,848, filed Aug. 29, 2022, the content of which is incorporated herein by reference in its entirety for all purposes.

### FIELD OF THE DISCLOSURE

Aspects of the present disclosure relate to systems and methods for synchronization of multiple displays.

### BACKGROUND OF THE DISCLOSURE

Electronic devices allow for individualized playback of media content. However, playback of content on multiple adjacent devices may lack coordination.

### SUMMARY OF THE DISCLOSURE

In some embodiments, the method includes, at a first electronic device configurable to communicate with a second electronic device and a third electronic device, receiving a first input requesting to initiate playback of media content. In some embodiments, in accordance with a determination that one or more criteria are satisfied, the method includes initiating synchronized playback of the media content on a display of the second electronic device and on a display of the third electronic device in accordance with the first input. In some embodiments, in accordance with a determination that the one or more criteria are not satisfied, the method includes forgoing initiating synchronized playback of the media content on the display of the second electronic device and on the display of the third electronic device.

In some embodiments, the method includes, at a first electronic device configurable to communicate with a second electronic device, receiving a first input requesting to initiate playback of media content. In some embodiments, in accordance with a determination that one or more criteria are satisfied, the method includes initiating synchronized playback of the media content on a display of the first electronic device and on a display of the second electronic device in accordance with the first input. In some embodiments, in accordance with a determination that the one or more criteria are not satisfied, the method includes forgoing initiating synchronized playback of the media content on the display of the first electronic device and on the display of the second electronic device.

### BRIEF DESCRIPTION OF THE DRAWINGS

FIGS. 1A-1B illustrate example environments in accordance with embodiments of the disclosure.

FIGS. 2A-2B are block diagrams illustrating example electronic device in accordance with embodiments of the disclosure.

FIG. 3 is a flowchart illustrating an example process for display synchronization in accordance with embodiments of the disclosure.

FIG. 4 is a flowchart illustrating an example process for display synchronization in accordance with embodiments of the disclosure.

### DETAILED DESCRIPTION

In some embodiments, the method includes, at a first electronic device configurable to communicate with a second electronic device and a third electronic device, receiving a first input requesting to initiate playback of media content. In some embodiments, in accordance with a determination that one or more criteria are satisfied, the method includes initiating synchronized playback of the media content on a display of the second electronic device and on a display of the third electronic device in accordance with the first input. In some embodiments, in accordance with a determination that the one or more criteria are not satisfied, the method includes forgoing initiating synchronized playback of the media content on the display of the second electronic device and on the display of the third electronic device.

In some embodiments, the method includes, at a first electronic device configurable to communicate with a second electronic device, receiving a first input requesting to initiate playback of media content. In some embodiments, in accordance with a determination that one or more criteria are satisfied, the method includes initiating synchronized playback of the media content on a display of the first electronic device and on a display of the second electronic device in accordance with the first input. In some embodiments, in accordance with a determination that the one or more criteria are not satisfied, the method includes forgoing initiating synchronized playback of the media content on the display of the first electronic device and on the display of the second electronic device. Additional details of display synchronization are described below.

Systems and methods for synchronization of multiple displays are described below. Synchronization of multiple displays can improve user experience for playback of media content. Multiple displays in a shared or enclosed space can be leveraged for shared playback of media content, including by way of example, the synchronization of playback of content on multiple displays can provide for a shared experience for those users and devices within the shared or enclosed space.

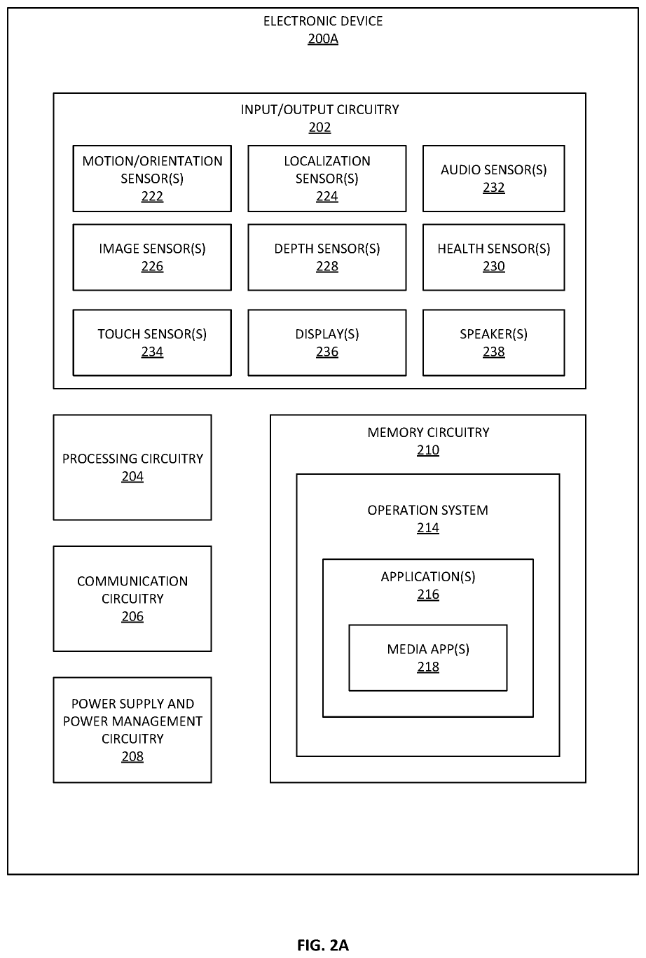

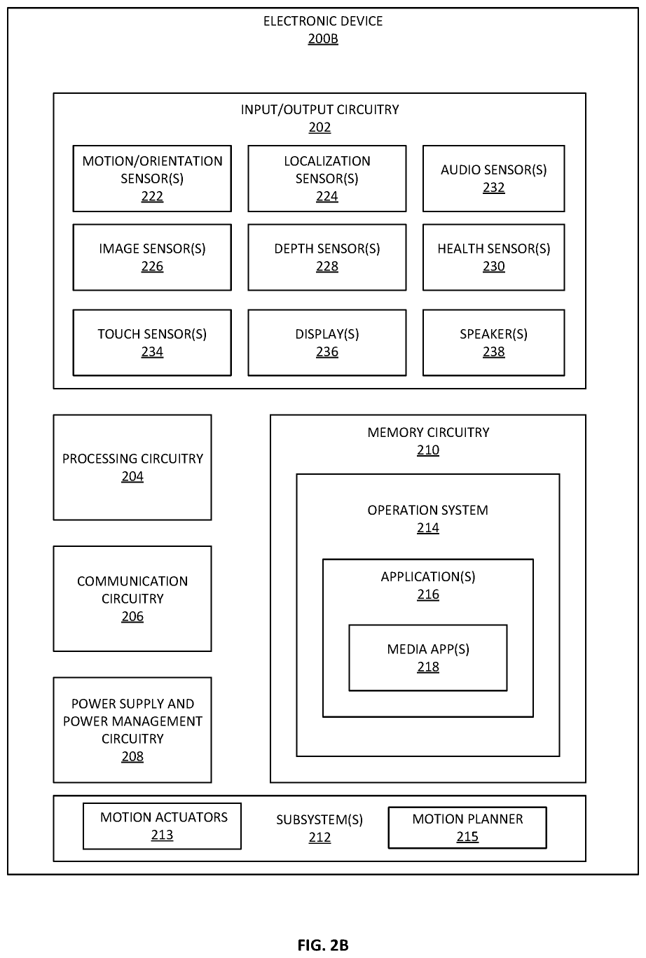

Embodiments of the present invention contemplate a variety of electronic devices. In some embodiments described herein, the electronic device is configured in a first configuration including a display such as a smart phone or tablet computer. An example first configuration for an electronic device is illustrated in FIG. 2A, and such electronic devices are sometimes referred to herein as “display devices” for ease of description due to the importance of the display interface for such devices. In some embodiments, the electronic device is configured in a second configuration. In some embodiments, in the second configuration the electronic device includes motor controllers and a motion planner. An example second configuration for an electronic device is illustrated in FIG. 2B, and such electronic devices are sometimes referred to herein as “mobile devices” for ease of description due to the importance of the mobility/transportation functionality for such devices.

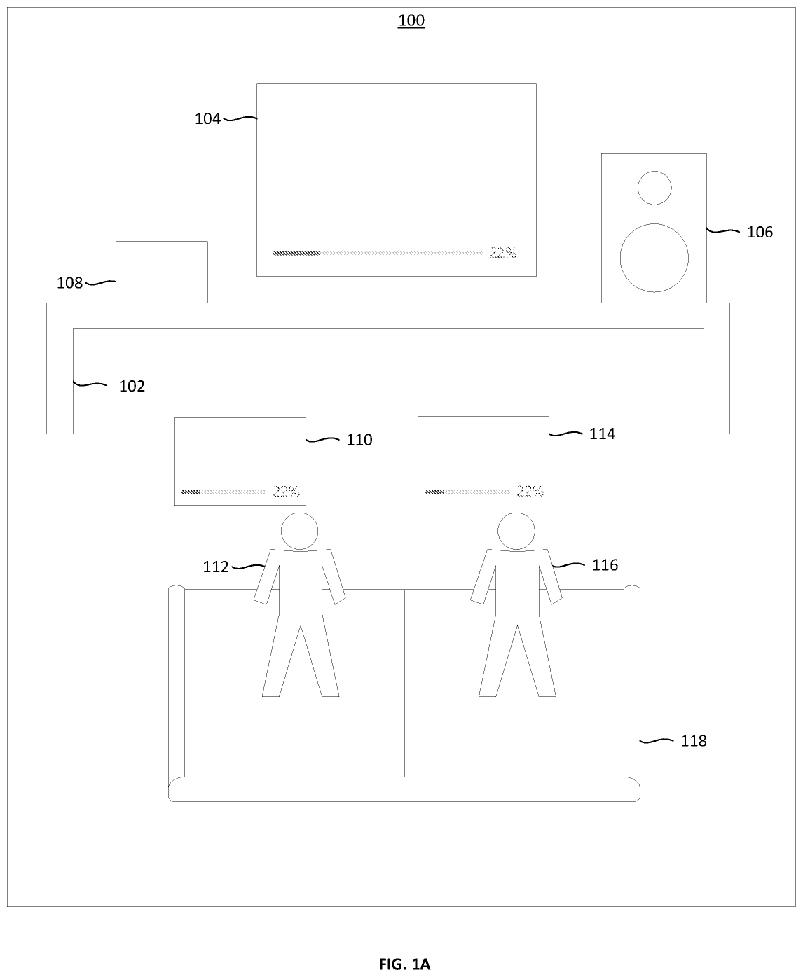

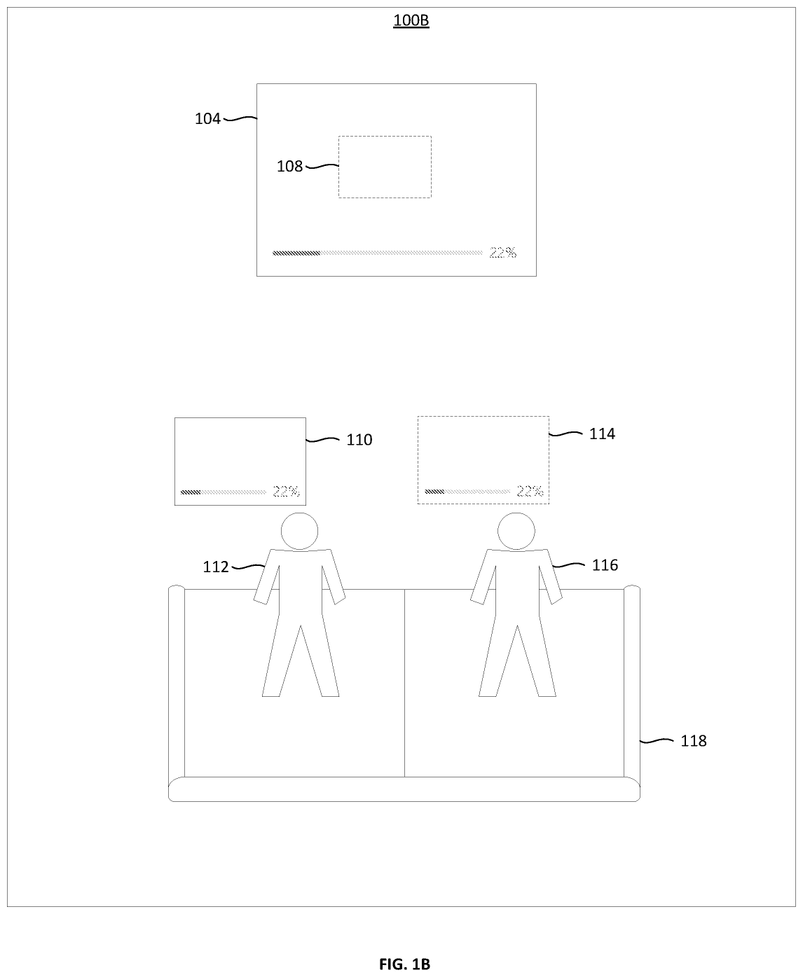

FIG. 1A illustrates an example environment 100 in accordance with some embodiments of the disclosure. Environment 100 includes one or more electronic devices including a display (also referred to as “display devices”), such as display device 104, display device 110 and display device 114. Example display device include mobile phones, tablet computers, laptop computers, televisions, infotainment systems, wearable devices, monitors, etc. In some embodiments, one or more of the display devices are non-portable or fixed in environment 100 during device use (e.g., display device 104). For example, the position of display device 104 does not change relative to seating 118 in environment 100 during device use. In some embodiments, one or more of the display devices is portable. For example, display devices 110 and 114 can be held by and move with users 112 and 116, respectively, as the user moves within (e.g., relative to) and outside of environment 100. In some embodiments, all of the display devices are non-portable or portable. The one or more display devices are used to play media content, optionally in a synchronized fashion as described herein. For example, FIG. 1A illustrates display devices 104, 110 and 114 each including a progress bar for the media content, optionally with a play head, presented on the display device. The play heads are synchronized to the same point in the media content. In some embodiments, the progress bar is presented to the user continuously, or the progress bar is presented or dismissed responsive to user inputs. In some embodiments, the progress bar is not presented to the user. In some embodiments, display devices 110 and 114 are used to play media content, optionally in a synchronized fashion as described herein (e.g., without necessarily synchronizing with display device 104). Examples of display synchronization include the synchronizing of interactive and non-interactive media content, such as music, videos, articles, and books.

Additionally, environment 100 optionally includes one or more speakers 106 configured to generate audio in support of media content playback. Environment 100 optionally includes a “hub device”, such as hub device 108, configured to store media content and/or synchronize playback among the one or more electronic devices including displays. Example hub devices include a smart home hub, a media or infotainment console, server, etc. In some embodiments, hub device 108 is outside of environment 100.

In some embodiments, the one or more display devices, one or more speakers, and the hub device are separate electronic devices. In some embodiments, some or all of the one or more display devices, one or more speakers, and the hub device are separate electronic devices are integrated into systems. For example, although not shown in FIG. 1A, display devices 110 and/or 114 optionally include one or more integrated speakers. In some embodiments, display device 104, one or more speaker 106, and hub device 108 are separate electronic devices supported on or integrated as part of media center (e.g., supported on support surface 102). In some embodiments, display device 104, one or more speaker 106, and hub device 108 are integrated into a single device (e.g., a smart television).

As described herein, environment 100 represents a confined space, optionally including seating. In some embodiments, synchronized playback of media content on displays of multiple electronic devices is restricted to devices within the confined space. For example, synchronized playback of media content occurs on two or more display devices 110, 114 (e.g., smart phones, tablets, etc. corresponding to electronic device 200A) in the confined space of environment 100. In some embodiments, the synchronized playback on two or more display devices 110, 114 is enabled by direct communication between the two or more display devices. In some embodiments, the synchronized playback on two or more display devices 110, 114 is enabled by hub device 108 in the confined space. In some embodiments, the confined space is defined by physical boundaries such as walls or other barriers. Confined spaces are optionally entertainment spaces including, but not limited to, a home theater, a living room, an interior of a vehicle (e.g., airplane, bus, car, boat etc.), a gaming room, etc.

In some embodiments, the confined space is an interior of an electronic device (e.g., a mobile device configured for transportation of a user, such as a vehicle). FIG. 1B illustrates an example environment 100B in accordance with some embodiments of the disclosure. In some embodiments, display device 104 corresponds to a built-in display with integrated hub device 108 (e.g., infotainment system) of the mobile device (e.g., corresponding to electronic device 200B), and the synchronized playback can occur between two or more display devices 110, 114 (e.g., smart phones, tablets, etc. corresponding to electronic device 200A) and/or between one or more display devices (e.g., smart phones, tablets, etc. corresponding to electronic device 200A) and one or more displays of the mobile device (e.g., corresponding to electronic device 200B). In some embodiments, the synchronized playback is enabled by direct communication between devices or is enabled by hub device 108 in the confined space (e.g., the infotainment system of the mobile device).

It is understood that, in some embodiments, the synchronized playback is optionally extended beyond the confined space under some circumstances (e.g., when a display device temporarily leaves the confined space, when a display device remains in wireless communication with an electronic device in the confined space using a limited range wireless communication protocol (e.g., Bluetooth, Wi-Fi, near field communication, Zigbee, etc.), when a display device remains authorized by an electronic device in the confined space, or when a display device is within a threshold distance of the confined space.

In some embodiments, the electronic device in environment 100 are communicatively coupled for unidirectional and/or bidirectional communication. In some embodiments, the communication is enabled by one or more wireless communication protocols and circuitry such as Wi-Fi, Bluetooth, Zigbee, cellular, satellite, etc. Although wireless communication is primarily described, it is understood that wired communication is optionally used in some embodiments (e.g., universal serial bus (USB), etc.)

FIGS. 2A-2B are block diagrams illustrating electronic devices 200A-200B in accordance with some embodiments of the disclosure. FIG. 2A is a block diagram illustrating an electronic device 200A in a first configuration in accordance with some embodiments of the disclosure. Electronic device 200A represents a display device such as a smart phone, tablet computer, laptop computer, media player, etc. FIG. 2B is a block diagram illustrating an electronic device 200B in a second configuration in accordance with some embodiments of the disclosure. Electronic device 200B represents a mobile device (e.g., a vehicle) that includes additional subsystem not included in electronic device 200A. It is understood that the block diagrams of FIGS. 2A-2B represents example architectures, but that some electronic devices may have more or fewer components and/or a different configuration of components than shown in FIGS. 2A-2B. Some of the components in FIGS. 2A-2B are implemented in hardware, software, firmware, or any combination thereof.

FIGS. 2A-2B illustrate that electronic devices 200A-200B optionally include input/output circuitry 202, processing circuitry 204, communication circuitry 206, power supply and power management circuitry 208, and memory circuitry 210. Electronic device 200B also includes one or more subsystems 212. Although not shown in FIGS. 2A-2B, the various components are optionally electrically coupled by one or more buses and/or using one or more interfaces and electrical connections.

Input/output circuitry 202 includes one or more devices for providing input to the electronic devices 200A-200B and for providing output from the electronic devices 200A-200B. In some embodiments, input/output circuitry 202 includes sensors such as motion and/or orientation sensor(s) 222, localization sensor(s) 224, image sensor(s) 226, depth sensor(s) 228, health sensor(s) 230, audio sensor(s) 232, touch sensor(s) 234, display(s) 236, speakers 238, among other possible sensors. Motion and/or orientation sensor(s) 222 optionally include one or more accelerometers, gyroscopes, and/or inertial measurement units (IMUs) to measure motion and/or orientation of electronic devices 200A-200B. Localization sensor(s) 224 be used to determine location, heading, and/or orientation of electronic devices 200A-200B. The localization sensor(s) 224 or localization system(s) optionally include a global navigation satellite system (GNSS) or sensor, an inertial navigation system (INS) or sensor, a global positioning system (GPS) or sensor, an altitude and heading reference system (AHRS) or sensor, a compass, etc. Image sensor(s) 226 and depth sensor(s) 228 optionally include sensors to generate two-dimensional or three-dimensional images, radio detection and ranging sensors or systems, light detection and ranging sensors or systems, visual or video detection and ranging sensors or systems, infrared sensors, optical sensors, camera sensors (e.g., color or grayscale), etc. Health sensor(s) 230 optionally include heart rate sensors, blood pressure sensors, blood oxygenation sensors, glucose sensors, respiratory sensors, and temperature sensors, among other possibilities. Audio sensor(s) 232 optionally include one or more microphones, optionally arranged in an array. Touch sensor(s) 234 optionally include touch sensors or touch sensor panels using resistive, capacitive, acoustic, optical, piezoelectric, or any other suitable sensing technology.

In some embodiments, input/output circuitry 202 includes output devices, such as speaker(s) 238 (e.g., corresponding to speaker(s) 106), display(s) 236 (e.g., corresponding to display devices 104, 110, 114, etc.), or haptic output devices (not shown) that can provide audio, visual, and/or tactile feedback to a user. Display(s) 236 optionally include optical components to generate images including liquid crystal displays, light-emitting diode displays, among other possible display technologies. In some embodiments, electronic devices 200A-200B include touch screen(s) comprising combination of a display and touch sensor(s).

It is understood that, in some embodiments, additional input/output devices are included in the electronic devices described herein, such as a keyboard, a mouse, a button, a knob, a slider, a touch sensor or touch sensor panel, a touchpad, a trackpad, a touch screen, a joystick, a proximity sensor, etc.

Processing circuitry 204 optionally includes one or more processors including microcontrollers, microprocessors, application specific integrated circuits (ASICs), programmable logic device (PLD), field-programmable gate arrays (FPGAs), central processing units (CPUs), graphics processing units (GPUs), digital signal processors (DSPs), or any suitable processing circuitry. Processing circuitry 204 is optionally used to perform any of the processes, methods, or functions described herein (e.g., optionally by executing instructions or programs stored in a non-transitory computer-readable storage medium). Some example functions include telephonic or video conferencing, electronic messaging or mailing, web browsing, image or video capturing, entertainment, etc. Additionally, as described herein, the functions include synchronizing playback of media content on multiple displays.

Communication circuitry 206 includes circuitry to provide for wired or wireless communication with other electronic devices. In some embodiments, the communication circuitry enables communication using different communication protocols such as Wi-Fi, Bluetooth, Zigbee, cellular, satellite, etc. In some embodiments, the communication circuitry includes one or more transmitter and/or receiver antennas to transmit and/or receive data for synchronizing playback of media content on multiple displays.

In some embodiments, power supply and power management circuitry 208 includes one or more energy storage devices (e.g., a battery or multiple batteries) to provide a power supply for the powered components of electronic devices 200A-200B. In some embodiments, power supply and power management circuitry 208 includes circuitry for wired or wireless charging of the one or more energy storage devices. In some embodiments, the power supply and power management circuitry 208 includes circuitry to manage power delivery and usage by the components of electronic devices 200A-200B, to manage charging of the one or more energy storage device(s), and/or to monitor the energy levels of the one or more energy storage devices.

Memory circuitry 210 optionally includes any suitable type of memory including but not limited to volatile or non-volatile memory (e.g., where data is maintained after all power is removed from electronic devices 200A-200B). Memory circuitry 210 optionally includes any suitable electronic, magnetic, optical, electromagnetic, infrared, or semiconductor system, apparatus, or device. The memory circuitry can include, but is not limited to, flash memory devices, random access memory (RAM) devices (e.g., dynamic random-access memory (DRAM), static random-access memory (SRAM), double-data-rate random-access memory (DDR RAM), or other high-speed RAM or solid-state RAM, etc.), read-only memory (ROM) devices, or erasable or electrically erasable programmable read-only memory devices (EPROM or EEPROM). In some embodiments, some of memory circuitry 210 is integrated within other components of electronic devices 200A-200B. In some embodiments, memory circuitry 210 is separate from the one or more other components of electronic devices 200A-200B and electrically coupled for read and/or write operations.

The memory circuitry 210 or a subset of the memory circuitry 210 can be referred as a computer-readable storage medium. Memory circuitry 210 and/or the non-transitory computer readable storage medium of memory circuitry 210 store programs, instructions, data modules, data structures or a subset or combination thereof. In some embodiments, memory circuitry 210 and/or the non-transitory computer readable storage medium store an operating system 214. In some embodiments, the operating system 214 manages one or more running applications 216 (e.g., by scheduling processing circuitry of electronic devices 200A-200B to execute the applications 216 using one or multiple processing cores). As described herein, data from some applications, such as a media application 218, are optionally obtained and/or used for synchronized playback of media content on multiple displays as described herein. Additionally, in some embodiments, memory circuitry 210 and/or non-transitory computer readable storage medium optionally have programs/instructions stored therein, which when executed by processing circuitry, cause the electronic devices 200A-200B (or the computing system more generally) to perform one or more functions and methods of one or more embodiments of this disclosure (e.g., synchronizing playback of media content on multiple displays). As used herein, a “non-transitory computer-readable storage medium” is any medium (excluding signals) that contains or stores programs/instructions for use by the electronic device (e.g., by processing circuitry).

Electronic device 200B in FIG. 2B includes subsystems 212 that are not included in electronic device 200A. For example, electronic device 200B includes one or more motion actuators 213. The motion actuators 213 optionally include motor controllers and systems, steering systems, brake systems to control movement of the wheels of electronic device 200B. Subsystems 212 optionally include a motion planner 215, which optionally uses a navigation system and/or autonomous or semi-autonomous processors and controllers. Subsystems 212 optionally include light systems environment controls, and entertainment systems. In some embodiments, the additional subsystems optionally include subsystems for synchronizing playback of media content on multiple displays, as described in more detail herein.

As described herein, the playback of media content on multiple displays is optionally synchronized to provide an improved user experience. As used herein, synchronization corresponds to alignment of a progress bar and/or a play head for the media content such that media content (e.g., video) is presented from each of the display devices (e.g., showing the same image of the video at the same time on each of the devices). Additionally, the synchronization corresponds to alignment of a progress bar and/or a play head for the media content such that media content (e.g., audio) is presented from each of the speaker devices (e.g., playing the same audio segment at the same time from each of the devices) and, when applicable, synchronized to the corresponding video.

Additionally, as described herein, the playback of media content on multiple displays is optionally synchronized in the context of a confined space. For example, the synchronization of playback of on content multiple displays is optionally limited to a confined to provide for a shared experience for those users and devices within the confined space. In this way, the playback of the media content is provided to those authorized to access the media content in the confined space. In some embodiments, the confined space is an interior of a mobile device, and the playback is synchronized for media content between multiple devices within the interior of the mobile device and/or between one or more displays of the mobile device and one or more user devices in the interior of the mobile device. In some embodiments, mobile device is a vehicle. In some embodiments, the media content is associated with the mobile device and is stored on or accessed from the mobile device (e.g., using a hub device, such as an infotainment system). In some embodiments, the media content is associated with a display device and is stored on and accessed from a display device in the interior of the mobile device, optionally using the mobile device as an intermediate access point for the other display device(s) in the interior of the mobile device. In some embodiments, the synchronized playback is initiated in accordance with (e.g., in response to) a request to initiate playback of the media content received from an input device of the mobile device or one of the other display devices within the mobile device.

As described herein, in some embodiments, one or more criteria need to be satisfied for synchronization of multiple displays. For example, in some embodiments, synchronization requires detecting the multiple display devices within the confined space. In some embodiments, the one or more criteria include authorization by a particular display device to participate in the synchronized display of media content. In some embodiments, the one or more criteria include an authentication by a particular display device within a mobile device (e.g., with hub device of the mobile device) to participate in the synchronized display of media content. In some embodiments, when the one or more criteria are satisfied, synchronized playback of the media content is initiated on displays of the multiple devices meeting the above criteria (e.g., those within the confined space, authenticated by the mobile device, and/or authorized to participate in synchronized display).

In some embodiments, when the one or more criteria are not satisfied, the system disallows (or forgoes) initiating synchronized playback of the media content. In some embodiments, disallowing (or forgoing) synchronized playback corresponds to initiating playback (or continuing playback) on just one display device (e.g., a display device that originated a request for playback of content). In some embodiments, disallowing (or forgoing) initiating synchronized playback corresponds to initiating playback (or continuing playback) on multiple display devices meeting the above criteria (e.g., those within the confined space, authenticated by the mobile device, and/or authorized to participate in synchronized display), without playback of the media content on the one or more devices not meeting the above criteria (e.g., those outside the confined space, not authenticated by the mobile device, and/or not authorized to participate in synchronized display). In some embodiments, disallowing (or forgoing) synchronized playback corresponds to initiating separate playback (or continuing playback) on multiple devices without further timing coordination, such as visual and/or audio play heads, between the devices.

As described herein, the display synchronization includes synchronization of multiple display devices within a mobile device or other confined space. In some embodiments, the multiple devices include at least a display of the mobile device (e.g., a non-portable display attached to the interior of the mobile device) and a user-portable display device (e.g., a mobile phone, tablet computer, etc.). In some embodiments, the multiple devices include at least a display two user-portable display devices (e.g., mobile phones, tablet computers, etc.) within the mobile device or other confined space. It is understood that the synchronization optionally includes additional display devices of the mobile device or confined space, or other user-portable devices.

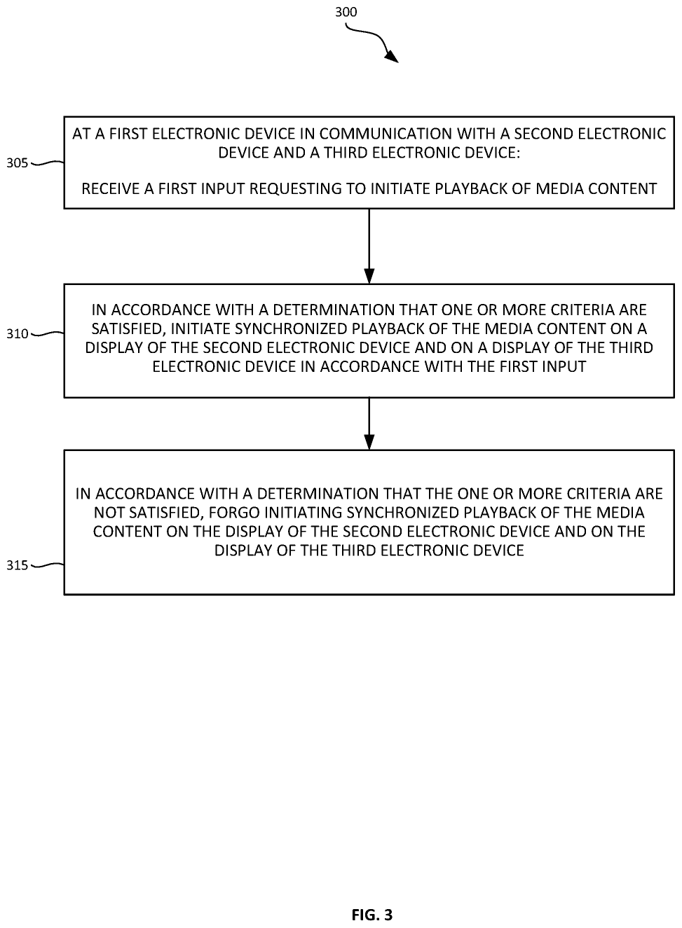

FIG. 3 is a flowchart illustrating an example process 300 for display synchronization in accordance with some embodiments of the disclosure. In some embodiments, process 300 is performed by electronic device or by a computing system including multiple electronic devices (e.g., hub device 108, display devices, 104, 110, and 114, or an electronic device 200B, such as a mobile device). In some embodiments, a non-transitory computer-readable storage medium (or more than one non-transitory computer-readable storage medium) stores instructions that, when executed by one or more processors of a mobile device (or by a computing system including the mobile device and one or more additional electronic devices), causes the mobile device (or computing system) to perform one or more operations of process 300. In some embodiments, one or more operations of process 300 can be modified without departing from the scope of this disclosure.

At block 305, a first input is received. The first input includes a request to initiate playback of media content. In some embodiments, the first input is a user input provided using input/output circuitry 202 (e.g., using the touch screen, using audio sensors, etc.) of a first electronic device (e.g., a mobile device) in communication with a second electronic device (e.g., a user-portable display device) and a third electronic device (e.g., a user-portable display device). In some embodiments, the first input is a user input provided using input/output circuitry 202 (e.g., using the touch screen, using audio sensors, etc.) of the second electronic device or the third electronic device. In some embodiments, the first input is received via a media application 218.

At block 310, in accordance with a determination that one or more criteria are satisfied, the system initiates synchronized playback of the media content on a display of the second electronic device and on a display of the third electronic device in accordance with the first input. For example, the media content plays on the second and third electronic devices with a time-synchronized progress bar and/or play head. In some embodiments, the first electronic device stores media content and wirelessly transmits the media content to the second and third electronic devices. In some embodiments, the one or more criteria enable synchronized display for those display devices that are within the confined space, authenticated by the mobile device, and/or authorized to participate in synchronized display.

At block 315, in accordance with a determination that the one or more criteria are not satisfied, in some embodiments, the system forgoes initiating synchronized playback of the media content on the display of the second electronic device and on the display of the third electronic device.

Although process 300 describes synchronized playback on a second electronic device and a third electronic device (e.g., tablet computer, smart phone) in the context of a first electronic device (e.g., communication with and/or within the confined of the first electronic device), in some embodiments, the synchronized playback on multiple display devices (e.g., the second electronic device and the third electronic device of process 300) can be implemented without the first device (e.g., using two or more display devices in a confined space different from the first electronic device).

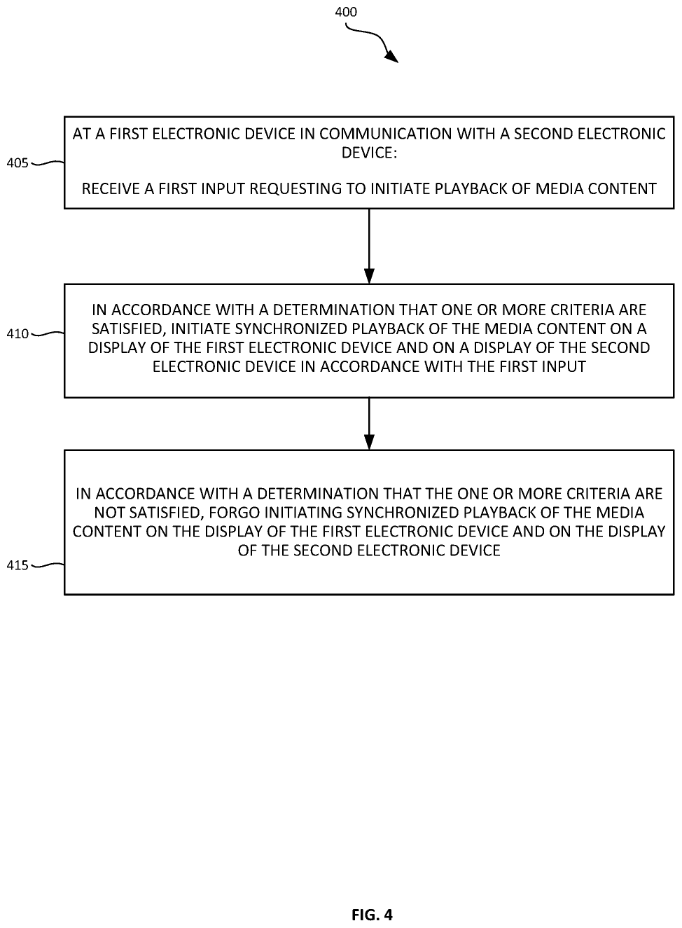

FIG. 4 is a flowchart illustrating an example process 400 for display synchronization in accordance with some embodiments of the disclosure. In some embodiments, process 400 is performed by electronic device or by a computing system including multiple electronic devices (e.g., hub device 108, display devices, 104, 110, and 114, or an electronic device 200B, such as a mobile device). In some embodiments, a non-transitory computer-readable storage medium (or more than one non-transitory computer-readable storage medium) stores instructions that, when executed by one or more processors of a mobile device (or by a computing system including the mobile device and one or more additional electronic devices), causes the mobile device (or computing system) to perform one or more operations of process 400. In some embodiments, one or more operations of process 400 can be modified without departing from the scope of this disclosure.

At block 405, a first input is received. The first input includes a request to initiate playback of media content. In some embodiments, the first input is a user input provided using input/output circuitry 202 (e.g., using the touch screen, using audio sensors, etc.) of a first electronic device (e.g., a mobile device or a user-portable display device) in communication with a second electronic device (e.g., a user-portable display device). In some embodiments, the first input is a user input provided using input/output circuitry 202 (e.g., using the touch screen, using audio sensors, etc.) of the second electronic device. In some embodiments, the first input is received via a media application 218.

At block 410, in accordance with a determination that one or more criteria are satisfied, the system initiates synchronized playback of the media content on a display of the first electronic device and on a display of the second electronic device in accordance with the first input. For example, the media content plays on the first and second electronic devices with a time-synchronized progress bar and/or play head. In some embodiments, the first electronic device stores media content and wirelessly transmits the media content to the second electronic device. In some embodiments, the one or more criteria enable synchronized display for those display devices that are within the confined space, authenticated by the mobile device, and/or authorized to participate in synchronized display.

At block 415, in accordance with a determination that the one or more criteria are not satisfied, in some embodiments, the system forgoes initiating synchronized playback of the media content on the display of the first electronic device and on the display of the second electronic device.

As described above, process 300 and 400 evaluate one or more criteria to determine whether to initiate synchronized playback of the media content on the multiple devices. In some embodiments, the one or more criteria include a criterion that is satisfied when the display devices are detected within the confined space of the first electronic device (and that is not satisfied for display devices that are detected outside of the confined space). As described herein, such a criterion is optionally used to provide a shared, synchronized display experience for devices within the confined space, such as the interior of a vehicle, without providing for playback of the media content on a display device outside the confined space. In some embodiments, detecting whether a display device is within the confined space includes using one or various technologies. For example, directional sensing and/or ranging technologies using radiofrequency identification, near-field communications, or ultrawideband (UWB), among other possibilities.

Additionally or alternative, in some embodiments, the one or more criteria include a criterion that is satisfied when the display devices are authenticated by the mobile device (and that is not satisfied for display devices that not authenticated by the mobile device). For example, in the context of processes 300 and 400, the first electronic device optionally authenticates the second and/or the third electronic device (e.g., the display devices). In some embodiments, the authentication includes sharing the same local network (e.g., Wi-Fi) or other near-field communications (Bluetooth, etc.). In some embodiments, the authentication includes a pairing process between the first electronic device and the second or third electronic devices.

Additionally or alternatively, in some embodiments, the one or more criteria include a criterion that is satisfied when the display devices (e.g., the second electronic device and/or the third electronic device in the context off processes 300 and 400) authorize playback (and that is not satisfied for display devices that do not authorize playback). In some embodiments, the authorization includes an authorization input (e.g., a user input opting into shared media content experience). In some embodiments, the user is presented with an opportunity to opt out of the synchronized playback of media content. In some embodiments, a user setting for the display device provides authorization or deny authorization without requiring an input. For example, the user can pre-authorize (or not) synchronized playback of media content using settings for the display device (e.g., “do not disturb” mode).

In some embodiments, initiating synchronized playback of media content on a display of multiple devices (e.g., the second electronic device and the third electronic device of process 300 or the first electronic device and the second electronic device of process 400) corresponds to starting playback of the media content with the progress bar and/or play head at the beginning of the media content (e.g., at time zero for the media content). In some embodiments, initiating synchronized playback of media content on a display of multiple devices (e.g., the second electronic device and the third electronic device of process 300 or the first electronic device and the second electronic device of process 400) corresponds to starting playback of the media content with the progress bar and/or play head in the middle of playback of the media content (e.g., at non-zero time for the media content). For example, the first input includes a request to initiate playback of media content in a shared playback experience (e.g., initiated at one of the electronic devices in a confined space), and the other electronic devices within the confined space are optionally prompted to join the shared playback experience, whether at the beginning or after the beginning of playback.

In some embodiments, the first input includes an input to begin shared playback of media content. In some embodiments, the request is received at a first electronic device (e.g., mobile device), within which the second electronic device and/or the third electronic device (e.g., user-portable electronic devices) are located. In some such embodiments, the first electronic device communicates with the second electronic device and/or the third electronic device, and cause a prompt at the second and/or third electronic devices to join the shared playback experience. For example, the prompt is optionally displayed on the display of the second and/or the third electronic devices. Additionally or alternatively, the prompt optionally includes audio and/or haptic feedback.

In some embodiments, the request is received at the second electronic device or the third electronic device (e.g., a user-portable electronic device) within the first electronic device (e.g., mobile device). For example, in some such embodiments, a request at the second electronic device causes a prompt to be presented in accordance with the request at the first electronic device and/or at the third electronic device (e.g., audio, visual, haptic, etc.). In some such embodiments, the first device in communication with the second electronic device causes the prompt to be presented to the third electronic device (e.g., the first electronic device acts as an intermediary for the prompt to the other devices).

In some embodiments, the second electronic device is configured to detect that it is within the first electronic device, and when the second electronic device is playing media content or requests playback of media content, the second electronic device prompts or otherwise suggests sharing playback with the first electronic device or other electronic devices within the confined space of the first electronic device. In some embodiments, the first electronic device is configured to detect the second and/or third electronic devices within the confined space of the first electronic device, and when the first electronic device is playing media content or requests playback of media content, the first electronic device prompts or otherwise suggests sharing playback with the second and/or third electronic devices.

In some embodiments, while a shared playback is ongoing, one or more additional electronic devices enter within the confined space. For example, while shared playback is ongoing on the first, second, and/or third electronic devices, a fourth electronic device may enter the confined space of the first electronic device. In some embodiments, the first electronic device detects the fourth electronic device and prompts the fourth electronic device to join the ongoing shared playback experience. In some such embodiments, the progress bar and/or play head of the fourth electronic device is synchronized with the other electronic devices in the shared playback experience. In some embodiments, the fourth electronic device detects an ongoing shared playback experience, and the fourth electronic device is used to request to join the ongoing shared playback experience. In some embodiments, when an input is received at the fourth electronic device declining to join the shared playback experience or when the fourth electronic device is in a mode (e.g., “do not disturb” mode) indicative of intention not to join a shared playback experience, the fourth electronic device forgoes initiating synchronized playback with the other devices.

In some embodiments, while a shared playback is ongoing, one or more electronic devices exit from within the confined space. For example, while shared playback is ongoing on the first, second, and/or third electronic devices, the second electronic device may exit the confined space of the first electronic device. In some embodiments, the first electronic device detects the departure of the second electronic device and terminate the shared playback experience for the second electronic device (e.g., cease playback of the media content on the second electronic device).

In some embodiments, synchronized playback of media content includes each display in a shared playback experience displaying the same media content. In some embodiments, synchronized playback of media content includes two or more displays in a shared playback experience displaying portions of the same media content in a synchronized fashion. For example, two displays (e.g., display device 110 and 114 in FIG. 1A) are optionally used together (e.g., side-by-side) such that each display include a portion of the media content. In other words, the displayed media content is split between the two displays (e.g., one display displays a first portion of the media content and one display displays a second, different portion of the media content). Thus, synchronized playback of media content enables increased screen size using two display devices. It is understood that although two displays are described above, that any number of displays can be used together in a similar fashion.

In some embodiments, synchronized playback of media content split across multiple displays occurs when certain splitting criteria are satisfied. In some embodiments, the splitting criteria include a criterion that is satisfied when the two (or more) displays are the same size. For example, splitting may be permitted across two displays with the same form factor (or at least a common dimension along a shared border), but may not be permitted across two displays with different form factors (or a different dimension along a shared border). For example, the former enables an equal split of the media content among the devices and provide an improved user experience compared with the latter. In some embodiments, the splitting criteria include a criterion that is satisfied when the two displays are within a threshold distance (e.g., 0.5 cm, 1 cm, 5 cm, etc.) of one another. For example, splitting of the media content (e.g., video) provides an expanded display and improved user experience when the two devices are close together, but may degrade the user experience when the two devices are not close together. In some embodiments, the splitting criteria include a criterion that is satisfied when the two displays are aligned or within a threshold distance of aligned with one another. For example, splitting of the media content (e.g., video) provides an expanded display and improved user experience when the two devices are well aligned, but may degrade the user experience when the two devices are not well aligned. In some embodiments, the first mobile device includes a receptacle or other holder configured to hold multiple display devices so as to easily enable satisfying the splitting criteria for the multiple display devices.

As described herein, the synchronization of multiple displays is not limited to each display presenting the identical content. In some embodiments, the synchronization of displays is used in the context of multi-player games to enable synchronization of gameplay across the multiple displays, but with each device presenting the game from a different perspective (e.g., from the perspective of each of the players).

In some embodiments, while synchronizing displays for playback of media content, audio is also played to accompany the synchronized display. The audio is optionally played by any of or a subset of the speakers in the confined space (e.g., speakers 106, speakers of devices 104, 110, and/or 114, speaker(s) 238 of electronic device 200A, speakers of a mobile device such as speaker(s) 238 of electronic device 200B (e.g., a mobile device)). The audio is optionally synchronized across the multiple speakers in the confined space.

In some embodiments, during a shared playback experience, media content is controlled (e.g., adjusting a characteristic of playback of media content) by any of the electronic device within the confined space of a mobile device or by the mobile device (e.g., the infotainment system controls, display device control, etc.). In some embodiments, a subset of the electronic devices or the mobile device are used to control the shared playback experience. In some embodiments, only a single electronic device is used to control the shared playback experience (e.g., the first electronic device corresponding to the confined space, or the electronic device requesting to initiate the shared playback experience). In some embodiments, a first subset of controls is available to be controlled by all devices (e.g., volume adjustment), but a second subset of controls is controlled by a subset of devices (e.g., pause, play, fast forward, rewind, skip, etc.).

The embodiments above contemplate the synchronization of playback across multiple electronic devices. Communications between electronic devices may facilitate the determining of whether multiple devices can and/or should become synchronized with one another. Implementors should ensure that an appropriate level of information, such as machine capability information rather than user's personal information, are used to facilitate synchronization. To the extent that personal information is used, implementers are reminded to abide by appropriate privacy regulations and practices. Such practices may include informing users of information to be shared, and obtaining use permission (e.g., opt-in) for such sharing.

1. A method comprising:
at a first electronic device configurable to communicate with a second electronic device and a third electronic device:
receiving a first input requesting to initiate playback of media content;
in accordance with a determination that one or more criteria are satisfied, initiating synchronized playback of the media content on a display of the second electronic device and on a display of the third electronic device in accordance with the first input; and
in accordance with a determination that the one or more criteria are not satisfied, forgoing initiating synchronized playback of the media content on the display of the second electronic device and on the display of the third electronic device.

2. The method of claim 1, further comprising:
detecting whether the second electronic device or the third electronic device is within a confined space of the first electronic device.

3. The method of claim 2, wherein the one or more criteria include a first criterion that is satisfied when the second electronic device and the third electronic device are detected within the confined space of the first electronic device.

4. The method of claim 2, wherein the first electronic device is a vehicle and the confined space is an interior of the vehicle.

5. The method of claim 2, further comprising:
detecting a fourth electronic device is outside a confined space of the first electronic device;
wherein initiating synchronized playback of the media content on the display of the second electronic device and on the display of the third electronic device in accordance with the first input comprises forgoing playback of the media content on a display of the fourth electronic device.

6. The method of claim 1, further comprising:
during synchronized playback of the media content on the display of the second electronic device and on the display of the third electronic device, detecting the second electronic device is outside a confined space of the first electronic device; and
ceasing playback of the media content on the display of the second electronic device.

7. The method of claim 1, wherein the one or more criteria include a criterion that is satisfied when the second electronic device and the third electronic device are authenticated by the first electronic device.

8. The method of claim 1, where synchronized playback of the media content comprises aligning in time a play head for the media content on the second electronic device with a play head for the media content on the third electronic device.

9. The method of claim 1, further comprising:
initiating synchronized playback of the media content on a display of the first electronic device in accordance with the first input where synchronized playback of the media content comprises aligning in time a play head for the media content on the first electronic device with the play head for the media content on the second electronic device and with the play head for the media content on the third electronic device.

10. The method of claim 1, wherein forgoing initiating synchronized playback of the media content on the display of the second electronic device and on the display of the third electronic device comprises initiating playback of the media content on the display of the second electronic device without initiating playback of the media content on the third electronic device.

11. The method of claim 1, wherein the one or more criteria include a criterion that is satisfied when the second electronic device or the third electronic device authorizes playback.

12. The method of claim 1, further comprising:
after initiating the synchronized playback of the media content on the display of the second electronic device and on the display of the third electronic device, detecting a fourth electronic device;
prompting the fourth electronic device to initiate playback of the media content on a display of the fourth electronic device; and
initiating synchronized playback of the media content on the display of the fourth electronic device.

13. The method of claim 1, wherein the second electronic device and the third electronic device are arranged side-by-side and initiating synchronized playback of the media content on the display of the second electronic device and on the display of the third electronic device comprises displaying a portion of the media content on the display of the second electronic device and a different portion of the media content on the display of the third electronic device.

14. The method of claim 1, further comprising:
after initiating the synchronized playback of the media content on the display of the second electronic device and on the display of the third electronic device, receiving a request to adjust a characteristic of playback of the media content at the first electronic device, the second electronic device, or the third electronic device; and
adjusting the characteristic of the playback of the media content at the second electronic device and the third electronic device.

15. The method of claim 1, wherein the media content is associated with the first electronic device.

16. The method of claim 1, wherein the media content is associated with the second electronic device or the third electronic device.

17. The method of claim 1, further comprising:
in accordance with the determination that the one or more criteria are satisfied, initiating synchronized playback of audio associated with the media content using a speaker of the first electronic device.

18. The method of claim 1, further comprising:
in accordance with the determination that the one or more criteria are satisfied, initiating synchronized playback of audio associated with the media content using a speaker of the second electronic device and using a speaker of the third electronic device in accordance with the first input.

19. A first electronic device configurable to communicate with a second electronic device and a third electronic device, the first electronic device comprising:
a display; and
processing circuitry configured to:
receive a first input requesting to initiate playback of media content;
in accordance with a determination that one or more criteria are satisfied, initiate synchronized playback of the media content on a display of the second electronic device and on a display of the third electronic device in accordance with the first input; and
in accordance with a determination that the one or more criteria are not satisfied, forgo initiating synchronized playback of the media content on the display of the second electronic device and on the display of the third electronic device.

20. A non-transitory computer readable storage medium storing one or more programs, the one or more programs comprising instructions, which when executed by a system including a first electronic device configurable to communicate with a second electronic device and a third electronic device, cause the system to:
in accordance with a determination that one or more criteria are satisfied, initiate synchronized playback of media content on a display of the second electronic device and on a display of the third electronic device in accordance with a first input requesting to initiate playback of the media content; and
in accordance with a determination that the one or more criteria are not satisfied, forgo initiating synchronized playback of the media content on the display of the second electronic device and on the display of the third electronic device.
